(19) United States
(12) Patent Application Publication
(10) Pub. No.: US 2009/0243393 A1
(43) Pub. Date: Oct. 1, 2009

(54) SEMICONDUCTOR DEVICE, DESIGNING METHOD AND DESIGNING APPARATUS OF THE SAME

(75) Inventors: Takafumi MIYAHARA, Kawasaki (JP); Kenichi Ushiyama, Kawasaki (JP)

Correspondence Address: Fujitsu Patent Center;C/O CPA Global, P.O. Box 52050, Minneapolis, MN, 55402, US

(73) Assignee: FUJITSU MICROELECTRONICS LIMITED, Tokyo (JP)

(21) Appl. No.: 12/411,607

(22) Filed: Mar. 26, 2009

(30) Foreign Application Priority Data
Mar. 27, 2008 (JP) 2008-084224

(51) Int. Cl. H02J 1/00; G06F 17/50

(52) U.S. Cl. 307/80; 716/6

(57) ABSTRACT

A designing method of a semiconductor device includes: changing a power supply voltage changing a design data of a semiconductor device with a first power supply voltage into a design data of a semiconductor device with a second power supply voltage which is lower than the first power supply voltage; performing a first static timing analysis detecting the timing error by performing a static timing analysis process based on the delay time of the semiconductor device with the second power supply voltage; and supplying a power supply voltage generating the design data to supply the first power supply voltage to power supply voltage lines of the cell blocks in which cells on paths where the timing errors are detected are included, and to supply the second power supply voltage to the power supply voltage lines of the other cell blocks.

### CROSS-REFERENCE TO RELATED APPLICATIONS

This application is based upon and claims the benefit of priority of the prior Japanese Patent Application No. 2008-084224, filed on Mar. 27, 2008, the entire contents of which are incorporated herein by reference.

### FIELD

The embodiments discussed herein are directed to a semiconductor device, a designing method and a designing apparatus thereof.

### BACKGROUND

In recent days, low power consumption of an LSI is demanded in many products (mainly in mobile relation). When the power consumption of an existing semiconductor chip is lowered, the easiest way is to decrease a power supply voltage (lowering voltage). However, operating current becomes small and operating speed slows down if the voltage of the semiconductor chip designed to be high voltage is lowered. Accordingly, there is a case when a timing error occurs and it is impossible to lower the voltage. Consequently, a method to lower the voltage while considering the timing is desired.

FIG. 10A and FIG. 10B are views to explain timing constraint of a semiconductor chip 1001. In FIG. 10A, the semiconductor chip 1001 has cells A1 to A4, and B1 to B4. The four cells A1 to A4 are connected in series, a power supply voltage of 1.2 V is supplied thereto, and they constitute a first path inputting an input signal INA and outputting an output signal OUTA. Respective delay times of the cells A1 to A4 are, for example, 100 ps. In this case, the output signal OUTA has a delay time of 400 ps relative to the input signal INA. When a design timing constraint of the first path is 500 ps, the delay time of 400 ps satisfies the design constraint.

Besides, the four cells B1 to B4 are connected in series, a power supply voltage of 1.2 V is supplied thereto, and they constitute a second path inputting an input signal INB and outputting an output signal OUTB. Respective delay times of the cells B1 to B4 are, for example, 100 ps. In this case, the output signal OUTB has a delay time of 400 ps relative to the input signal INB. When a design timing constraint of the second path is 1200 ps, the delay time of 400 ps satisfies the design constraint.

As stated above, when the power supply voltage is 1.2 V, the delay times of the first path and the second path satisfy the design constraint.

FIG. 10B is a view illustrating the delay times when the power supply voltage of the semiconductor chip 1001 in FIG. 10A is lowered from 1.2 V to 1.0 V. When the power supply voltage is lowered, the delay times of the cells A1 to A4 and B1 to B4 become long.

When the power supply voltage of 1.0 V is supplied to the four cells A1 to A4, the respective delay times of the cells A1 to A4 become, for example, 150 ps. In this case, the output signal OUTA has the delay time of 600 ps relative to the input signal INA. When the design timing constraint of the first path is 500 ps, the delay time of 600 ps does not satisfy the design constraint, and the timing error occurs.

On the other hand, when the power supply voltage of 1.0 V is supplied to the four cells B1 to B4, the respective delay times of the cells B1 to B4 become, for example, 150 ps. In this case, the output signal OUTB has the delay time of 600 ps relative to the input signal INB. When the design timing constraint of the second path is 1200 ps, the delay time of 600 ps satisfies the design constraint.

When the semiconductor chip designed to be high power supply voltage is changed into low power supply voltage as a measure for the low power consumption, there is a case when the timing error occurs in the first path of which timing is tight, caused by increase of a path delay time, and the semiconductor chip does not operate under the low power supply voltage.

FIG. 11A and FIG. 11B are views illustrating a method preventing the timing error occurred resulting from the lowing of the power supply voltage of the semiconductor chip 1001. As illustrated in FIG. 11A, the timing error does not occur in the second path including the cells B1 to B4 even when the power supply voltage is made to be the low voltage of 1.0 V, and therefore, the low power supply voltage of 1.0 V is supplied to the cells B1 to B4. On the other hand, the timing error occurs in the first path including the cells A1 to A4 when the power supply voltage is the low voltage of 1.0 V, but the timing error does not occur when the power supply voltage is the high voltage of 1.2 V. Accordingly, the high power supply voltage of 1.2 V is supplied to the cells A1 to A4. As stated above, the timing error does not occur if the power supply voltage of the cells A1 to A4 is set to be the high voltage of 1.2 V, and the power supply voltage of the cells B1 to B4 is set to be the low voltage of 1.0 V.

FIG. 11B is a view illustrating an actual layout of the semiconductor chip 1001 in FIG. 11A. In the actual layout, regions of the cells A1 to A4 and regions of the cells B1 to B4 are not separated, and the regions of the cells A1 to A4 and the regions of the cells B1 to B4 are dispersed. Accordingly, it is difficult to separate the power supplies between the high power supply voltage regions of the cells A1 to A4 and the low power supply regions of the cells B1 to B4. Besides, the excessive number of processes is required for a layout adjustment of the semiconductor chip 1001, even if the separation of the power supplies is possible.

FIG. 12 is a flowchart illustrating a designing method of a semiconductor chip. A net list 1201 is a circuit design data of the semiconductor chip, and it is verified that the timing error does not occur when the power supply voltages of all cells are the high voltages of 1.2 V as illustrated in FIG. 10A. After that, it is assumed that needs occur to lower the power supply voltage from 1.2 V to 1.0 V. Hereinafter, a method to lower the power supply voltage of the semiconductor chip is described.

At first, the power supply voltages of all cells are changed from 1.2 V to 1.0 V for the net list 1201. Next, a layout design process (floor plan) is performed based on the net list 1201 at step 1202. Next, a placement and wiring process is performed at step 1203. Next, an RC (resistance and capacitance values) extraction and the delay calculation process are performed, to output a delay time at step 1204. As stated above, the delay time becomes short when the power supply voltage is high, and becomes long when the power supply voltage is low. Next, a static timing analysis process (STA) is performed at step 1205.

Next, it is checked whether a timing verification is passed or not by comparing the above-stated calculated delay time and the design timing constraint at step 1206. The process goes to step 1208 if it is passed, and goes to step 1207 if it is not passed. At the step 1208, the designing process is completed.

As illustrated in FIG. 10B, the delay time increases when the power supply voltage is lowered, and there is a case when the timing error occurs, for example, in the first path including the cells A1 to A4 and the timing verification is not passed. In that case, the process goes to the step 1207. At the step 1207, a timing adjusting process such as a buffer insertion is performed, and the process returns to the step 1203. After that, the above-stated processes are repeated.

As stated above, when the power supply voltage is lowered, the power supply voltage is changed from the high voltage to the low voltage, the static timing analysis process at the step 1205 is performed again, and the timing adjusting process is performed at the step 1207 for a portion where the timing error occurs.

In this case, when the power supply voltage is changed from the high voltage to the low voltage, there is a case when the timing verification is not passed even if the timing adjusting processes at the step 1207 are performed for several times. Besides, there is a case when a specification is reexamined because changes in an operating frequency and constraint condition are required under the low power supply voltage. In these cases, the number of processes increases drastically.

Besides, a delay calculation method of a semiconductor integrated circuit, in which it is determined whether a timing violation occurs or not based on a timing verification result by a timing verification unit, and it is judged whether a delay calculation under an operation power supply voltage condition in higher voltage is possible or not by referring to a voltage condition management data when the timing violation is detected, is described in Japanese Laid-open Patent Publication No. 2001-325320.

Besides, a designing method of a semiconductor integrated circuit, including plural wiring paths having one or more transistor(s) in a middle, in which delay times of respective wiring paths are calculated after a circuit design is performed by using transistors with a predetermined threshold value or more, and a correction is performed so as to decrease the threshold values of the transistors inside the wiring paths exceeding a predetermined delay time, is described in Japanese Laid-open Patent Publication No. 09-319775.

### SUMMARY

At least one embodiment of the present invention provides a designing method of a semiconductor device including: changing a power supply voltage inputting a design data of a semiconductor device with a first power supply voltage which is divided into plural cell blocks and without timing error, and changing the design data of the semiconductor device with the first power supply voltage into a design data of a semiconductor device with a second power supply voltage which is lower than the first power supply voltage; performing a first delay calculation calculating a delay time of the semiconductor device with the second power supply voltage based on the design data of the semiconductor device with the second power supply voltage; performing a first static timing analysis detecting the timing error by performing a static timing analysis process based on the delay time of the semiconductor device with the second power supply voltage; and supplying a power supply voltage generating a design data to supply the first power supply voltages to power supply voltage lines of the cell blocks in which cells on paths where the timing errors are detected are included, and to supply the second power supply voltages to the power supply voltage lines of the other cell blocks.

Additional objects and advantages of the embodiment will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a view illustrating a semiconductor chip designed by a designing apparatus of an example embodiment of the present invention;

FIG. 2 is a view illustrating a wiring method of power supply voltage lines and reference potential lines inside the semiconductor chip in FIG. 1;

FIG. 3 is a view illustrating a wiring method of high power supply voltage supply lines, low power supply voltage supply lines, and common reference potential supply lines inside the semiconductor chip;

FIG. 4 is a view in which the power supply voltage lines inside all cell blocks of the semiconductor chip are connected to the low power supply voltage supply lines;

FIG. 5 is a view in which the power supply voltage lines inside cell blocks where timing errors occur are connected to the high power supply voltage supply lines;

FIG. 6 is a flowchart illustrating a designing method of a semiconductor chip with high power supply voltage;

FIG. 7 is a flowchart illustrating a designing method in which the power supply voltage of the semiconductor chip with high power supply voltage is lowered;

FIG. 8 is a flowchart illustrating the designing method in which the power supply voltage of the semiconductor chip with high power supply voltage is lowered;

FIG. 9 is a block diagram illustrating a hardware configuration example of a computer constituting a designing apparatus of a semiconductor device according to an example embodiment of the present invention;

FIG. 10A and FIG. 10B are views to explain a timing constraint of a semiconductor chip;

FIG. 11A and FIG. 11B are views illustrating a method preventing a timing error occurring due to the low power supply voltage of the semiconductor chip; and

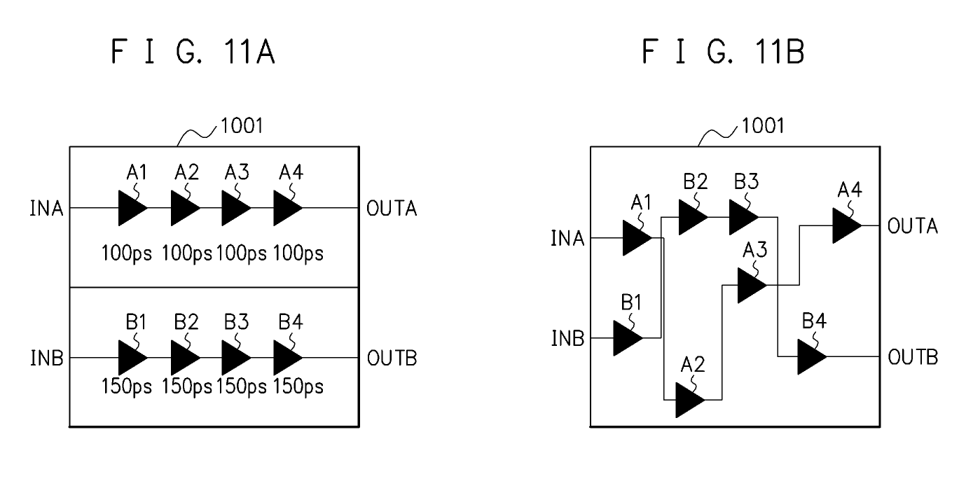

FIG. 12 is a flowchart illustrating a designing method of a semiconductor chip.

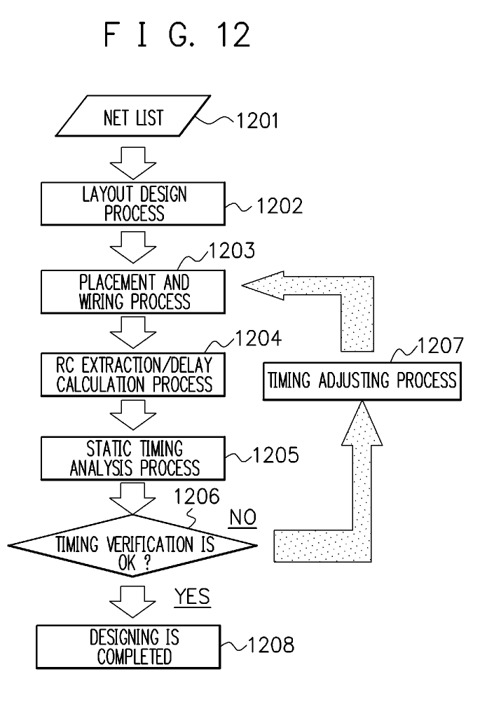

### DESCRIPTION OF THE EXAMPLE EMBODIMENTS

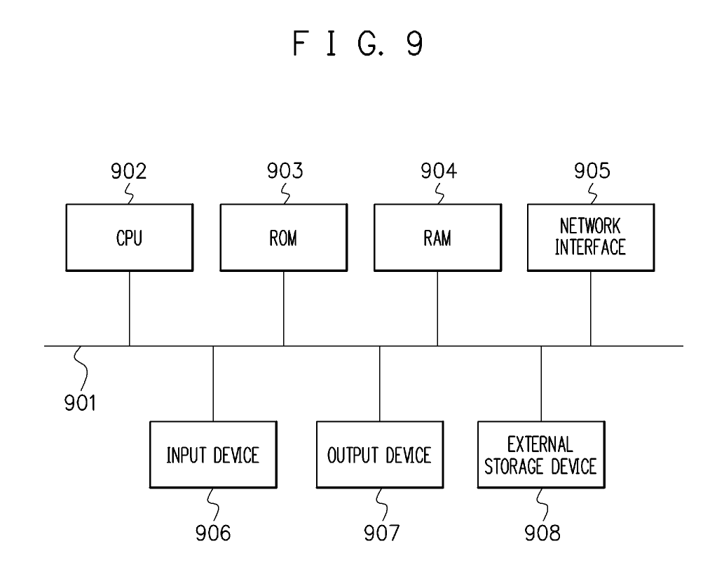

FIG. 9 is a block diagram illustrating a hardware configuration example of a computer constituting a designing apparatus of a semiconductor device according to an example embodiment of the present invention. It is possible for this computer to generate a net list design data by a CAD (computer-aided design), and to perform a static timing analysis of a design data of which power supply voltage is lowered.

A central processing unit (CPU) 902, a ROM 903, a RAM 904, a network interface 905, an input device 906, an output device 907 and an external storage device 908 are connected to a bus 901.

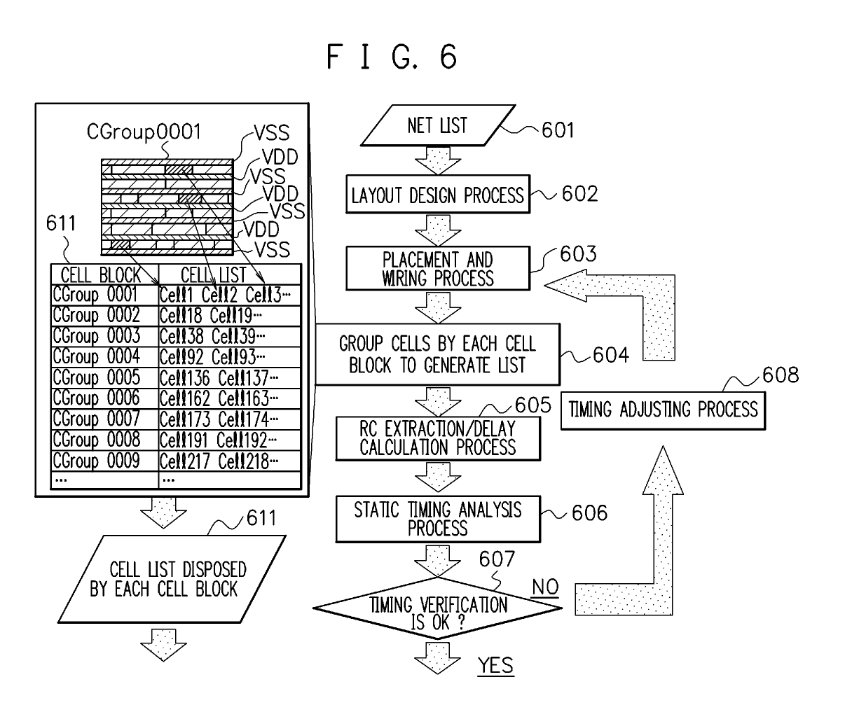

The CPU 902 performs a data processing and calculation, and controls the above-stated constitutional units connected via the bus 901. A boot program is stored in the ROM 903 in advance, and the computer is activated by this boot program which is executed by the CPU 902. Computer programs are stored in the external storage device 908, copied to the RAM 904, and executed by the CPU 902. It is possible for the computer to perform designing processes and so on in later-described FIG. 6 to FIG. 8 by executing the computer programs.

The external storage device 908 is, for example, a hard disk storage device and so on, and storage contents thereof are not lost if a power supply is turned off. It is possible for the external storage device 908 to record the computer programs, the net list design data, and so on to a recording medium, and to read the computer programs and so on from the recording medium.

It is possible for the network interface 905 to input/output the computer programs and the net list design data and so on to/from the network. The input device 906 is, for example, a keyboard, a pointing device (mouse), or the like, and various kinds of designations, inputs, and so on can be performed. The output device 907 is a display, a printer, or the like, and it is possible to display or print.

The computer executes the program, and thereby, the present embodiment can be realized. Besides, a unit to supply the programs to the computer, for example, a computer readable recording medium such as a CD-ROM recording such programs, or a transmission medium such as Internet transmitting such programs can be applied as the embodiments. Besides, a computer program product such as the above-stated computer readable recording medium recording the programs can be applied as the embodiment. The above-stated programs, recording medium, transmission medium and computer program product are included in a range. For example, a flexible disk, a hard disk, an optical disk, a magnetic optical disk, a CD-ROM, a magnetic tape, a nonvolatile memory card, a ROM, and so on can be used as the recording media.

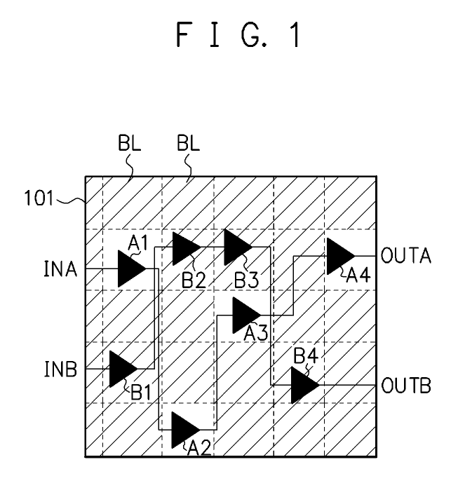

FIG. 1 is a view illustrating a semiconductor chip (semiconductor device) 101 designed by a designing apparatus of the present embodiment. The semiconductor chip 101 is divided into two-dimensional plural cell blocks BL illustrated by dotted lines. The semiconductor chip 101 has cells A1 to A4 and B1 to B4. The four cells A1 to A4 are connected in series, and constitute a first path inputting an input signal INA and outputting an output signal OUTA. Besides, the four cells B1 to B4 are connected in series, and constitute a second path inputting an input signal INB and outputting an output signal OUTB.

At first, a semiconductor chip 101 with high power supply voltage (for example, 1.2 V) is designed responding to current needs, while expecting to lower the power supply voltage in future. The high power supply voltage (for example, 1.2 V) is supplied to the cells A1 to A4 and B1 to B4.

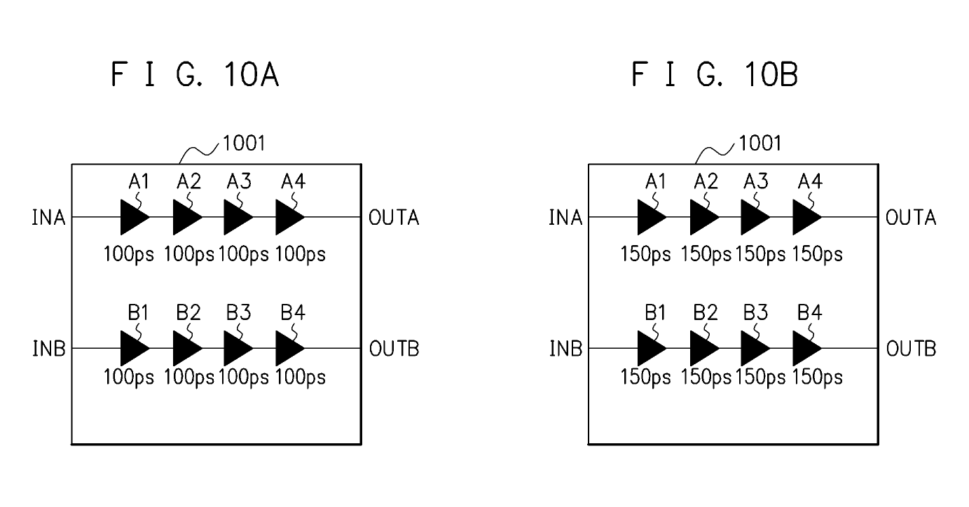

As same as in FIG. 10A, the delay times of the respective cells A1 to A4 are, for example, 100 ps. In this case, the output signal OUTA has the delay time of 400 ps relative to the input signal INA. When the design timing constraint of the first path is 500 ps, the delay time of 400 ps satisfies the design constraint.

Besides, the delay times of the respective cells B1 to B4 are, for example, 100 ps. In this case, the output signal OUTB has the delay time of 400 ps relative to the input signal INB. When the design timing constraint of the second path is 1200 ps, the delay time of 400 ps satisfies the design constraint.

As stated above, in case of the high power supply voltage of 1.2 V, the delay times of the first path and the second path satisfy the design constraints, the timing verification is passed, and the semiconductor chip is manufactured.

Next, the one in which the power supply voltage of the above-stated semiconductor chip 101 with high power supply voltage (for example, 1.2 V) is lowered is designed. The low power supply voltage (for example, 1.0 V) is supplied to the cells A1 to A4 and B1 to B4 inside the semiconductor chip 101. When the power supply voltage is lowered, operating current becomes small, and therefore, the delay times of the cells A1 to A4, B1 to B4 become long.

As same as in FIG. 10B, when the power supply voltage of 1.0 V is supplied to the four cells A1 to A4, the delay times of the respective cells A1 to A4 become, for example, 150 ps. In this case, the output signal OUTA has the delay time of 600 ps relative to the input signal INA. When the design timing constraint of the first path is 500 ps, the delay time of 600 ps does not satisfy the design constraint, and a timing error occurs.

On the other hand, when the power supply voltage of 1.0 V is supplied to the four cells B1 to B4, the delay times of the respective cells B1 to B4 become, for example, 150 ps. In this case, the output signal OUTB has the delay time of 600 ps relative to the input signal INB. When the design timing constraint of the second path is 1200 ps, the delay time of 600 ps satisfies the design constraint.

When the semiconductor chip 101 designed to be high power supply voltage is changed into low voltage as a measure for low power consumption, the first path of which timing is tight becomes the timing error caused by increase of the path delay times, and it does not operate in low voltage.

Next, processes to eliminate the timing error are performed. In the present embodiment, the semiconductor chip 101 is divided into plural cell blocks BL, and the cell blocks BL are disposed on the semiconductor chip 101 in a grid state. Internal power supply voltages are made selectable from two power supplies in high voltage and low voltage by each cell block BL.

In the first path including the cells A1 to A4, the timing error occurs under the low power supply voltage (for example, 1.0 V), but the timing error does not occur under the high power supply voltage (for example, 1.2 V), and therefore, the high power supply voltage (1.2 V) is supplied to the cell blocks BL including the cells A1 to A4.

On the other hand, in the second path including the cells B1 to B4, the timing error does not occur under the low power supply voltage (for example, 1.0 V), and therefore, the low power supply voltage (1.0 V) is supplied to the cell blocks BL including the cells B1 to B4.

As stated above, the power supply voltage of the semiconductor chip 101 is lowered, and the timing verification is performed. At this time, the low power supply voltage is supplied to all of the cell blocks BL inside the semiconductor chip 101. When the timing error occurs by the timing verification, an adjustment is performed so that the high power supply voltage is supplied to the cell blocks of the cells included in the path where the timing error occurs under the low power supply voltage. It is possible to eliminate the timing error by an adjusting process in short time without redoing a layout design, because it is only to change the selection of the two kinds of power supply voltages supplied to by the respective cell blocks.

Accordingly, the high power supply voltage (for example, 1.2 V) is supplied to the first path including the cells A1 to A4, and the timing error does not occur. Besides, the low power supply voltage (for example, 1.0 V) is supplied to the second path including the cells B1 to B4, and the timing error does not occur. It is possible for the semiconductor chip 101 including the first and second paths to reduce the power consumption, because the lowering of the voltage is possible in, at least, a part of the cell blocks. Namely, it is possible to reduce the power consumption in proportion to the number of cells operating under the low power supply voltage.

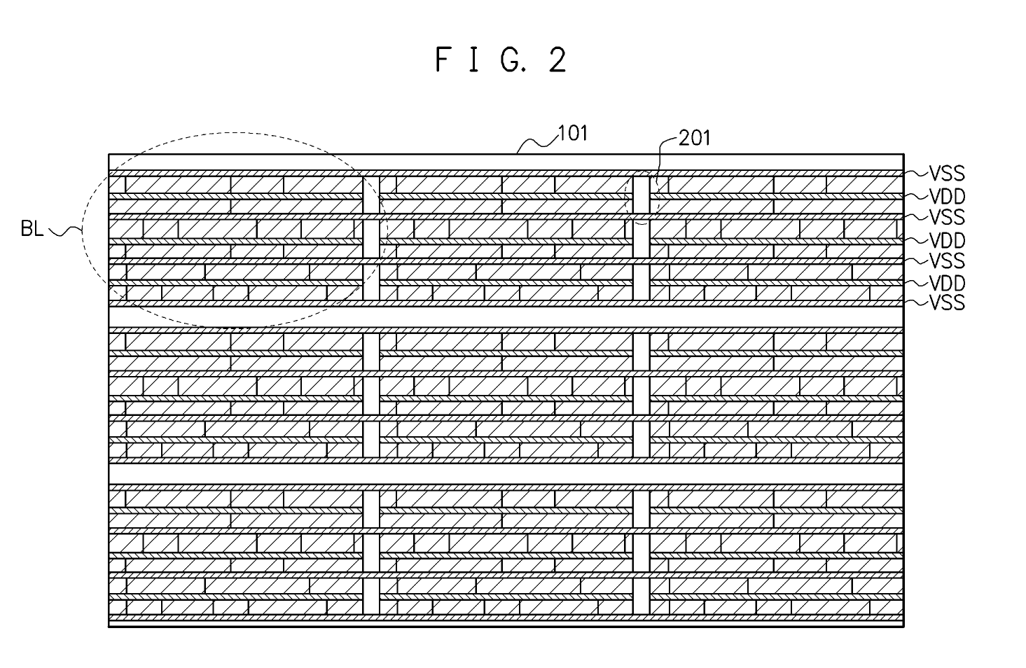

FIG. 2 is a view illustrating a wiring method of power supply voltage lines VDD and reference potential lines VSS inside the semiconductor chip 101 in FIG. 1. The semiconductor chip 101 is divided into plural cell blocks BL. The plural power supply voltage lines VDD and reference potential lines (ground potential lines) VSS are wired in each cell block BL. The power supply voltage lines VDD inside each cell block BL can be connected to either of two power supplies of high power supply voltage or low power supply voltage, and they are separated by each cell block BL at separating regions 201. On the other hand, the reference potential lines VSS inside all cell blocks BL are connected with each other, and can be connected to a common reference potential line.

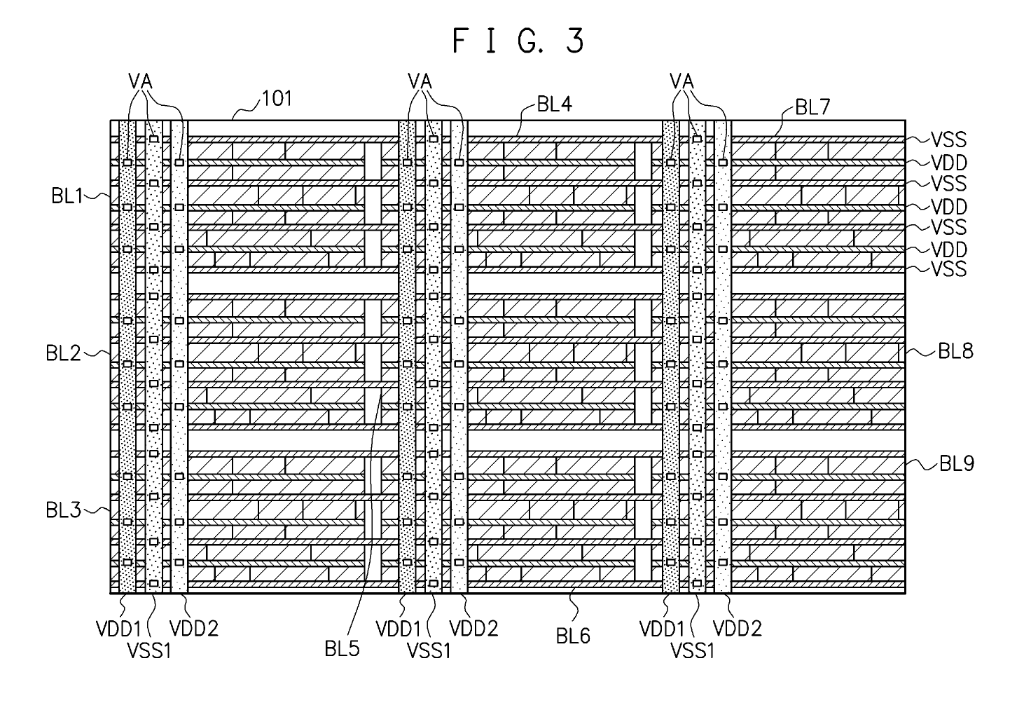

FIG. 3 is a view illustrating a wiring method of high power supply voltage supply lines VDD1, low power supply voltage supply lines VDD2, and common reference potential supply lines VSS1 inside the semiconductor chip 101. Wiring processes of the high power supply voltage supply lines VDD1, the low power supply voltage supply lines VDD2, and the common reference potential supply lines VSS1 are performed after wiring processes of the power supply voltage lines VDD and the reference potential lines VSS in FIG. 2. The semiconductor chip 101 has, for example, nine cell blocks BL1 to BL9. The cell blocks BL1 to BL9 correspond to the cell blocks BL in FIG. 1 and FIG. 2.

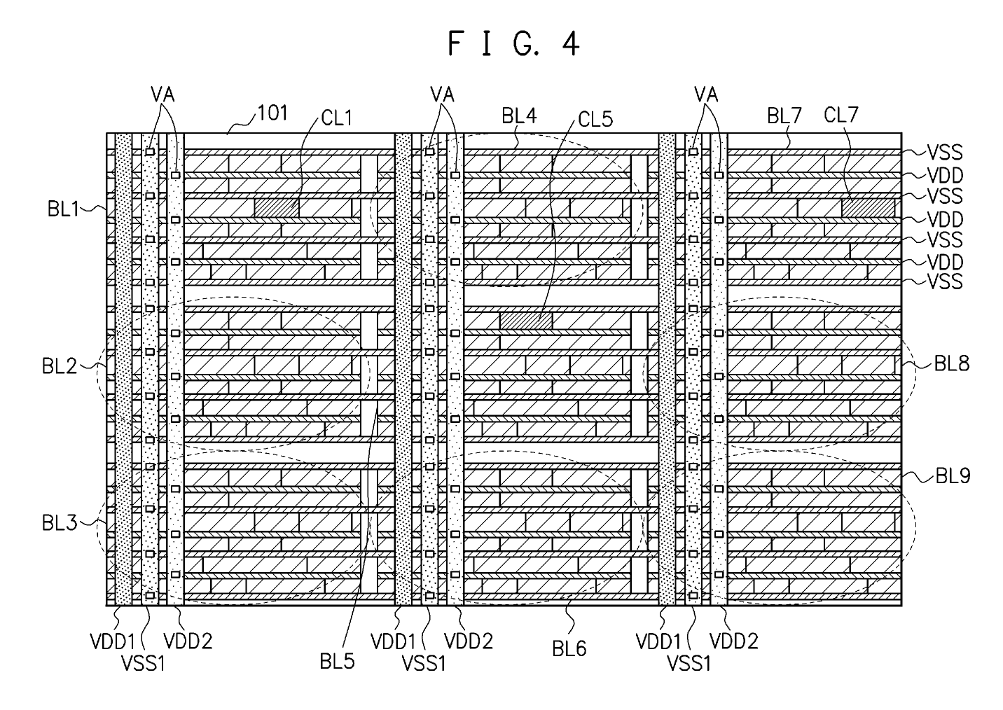

The power supply lines VDD inside each of the cell blocks BL1 to BL9 are connected to either the high power supply voltage supply line VDD1 or the low power supply voltage supply line VDD2 by a selection of via connection portions VA inside via holes. In FIG. 3, the via connection portions VA connect both the high power supply voltage supply line VDD1 and the low power supply voltage supply line VDD2 to the power supply voltage lines VDD, but actually, either the via connection portion VA of the high power supply voltage supply line VDD1 or the via connection portion VA of the low power supply voltage line VDD2 is selected. Details are described with reference to FIG. 4. The common reference potential supply lines VSS1 are connected to the reference potential lines VSS of the respective cell blocks BL1 to BL9 via the via connection portions VA inside the via holes.

FIG. 4 is a view in which the power supply voltage lines VDD inside all cell blocks BL1 to BL9 of the semiconductor chip 101 are connected to the low power supply voltage supply lines VDD2. The power supply voltage lines VDD inside all cell blocks BL1 to BL9 are connected to the low power supply voltage supply lines VDD2 via the via connection portions VA so as to lower the voltage of the semiconductor chip 101 with high power supply voltage. A static timing analysis process of the semiconductor chip 101 with low power supply voltage is performed under the state. A case is described as an example when the timing errors occur at three cells CL1, CL5 and CL7 as a result of the static timing analysis process. The cell CL1 is a cell inside the cell block BL1. The cell CL5 is a cell inside the cell block BL5. The cell CL7 is a cell inside the cell block BL7. Here, it is verified that the timing error does not occur at all cells in the semiconductor chip 101 with high power supply voltage. Accordingly, the cells CL1, CL5 and CL7 are the cells of paths of which timing margins are small, and therefore, the timing errors do not occur under the high power supply voltage, but the timing errors occur under the low power supply voltage. On the other hand, the timing errors do not occur at six cell blocks BL2, BL3, BL4, BL6, BL8 and BL9 under both the high power supply voltage and the low power supply voltage. As a result of the above-stated static timing analysis process, it turns out that the power supply voltages of the six cell blocks BL2, BL3, BL4, BL6, BL8 and BL9 can be lowered, and the power supply voltages of the cell blocks BL1, BL5 and BL7 including the three cells CL1, CL5 and CL7 cannot be lowered.

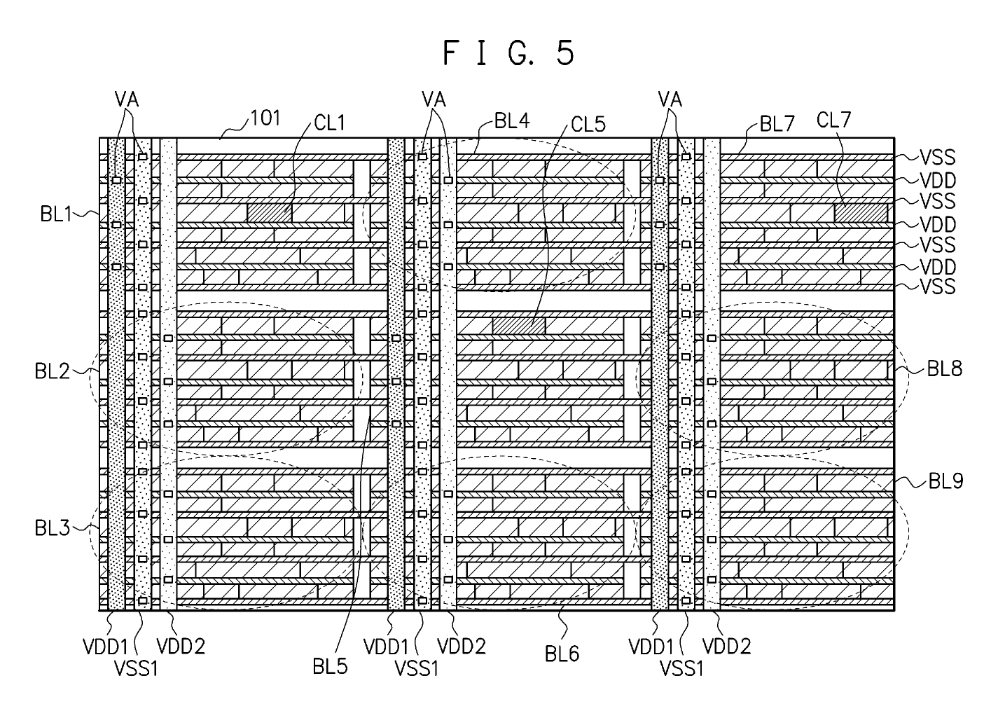

FIG. 5 is a view in which the power supply voltage lines VDD inside the cell block where the timing error occurs are connected to the high power supply voltage supply lines VDD1. As a result of the static timing analysis process of the above-stated semiconductor chip with low power supply voltage, the power supply voltage lines VDD are connected to the low power supply voltage supply lines VDD2 via the via connection portions VA because the timing errors do not occur at the six cell blocks BL2, BL3, BL4, BL6, BL8 and BL9. On the other hand, the power supply voltage lines VDD are connected to the high power supply voltage supply lines VDD1 via the via connection portions VA because the timing errors occur at the three cell blocks BL1, BL5 and BL7.

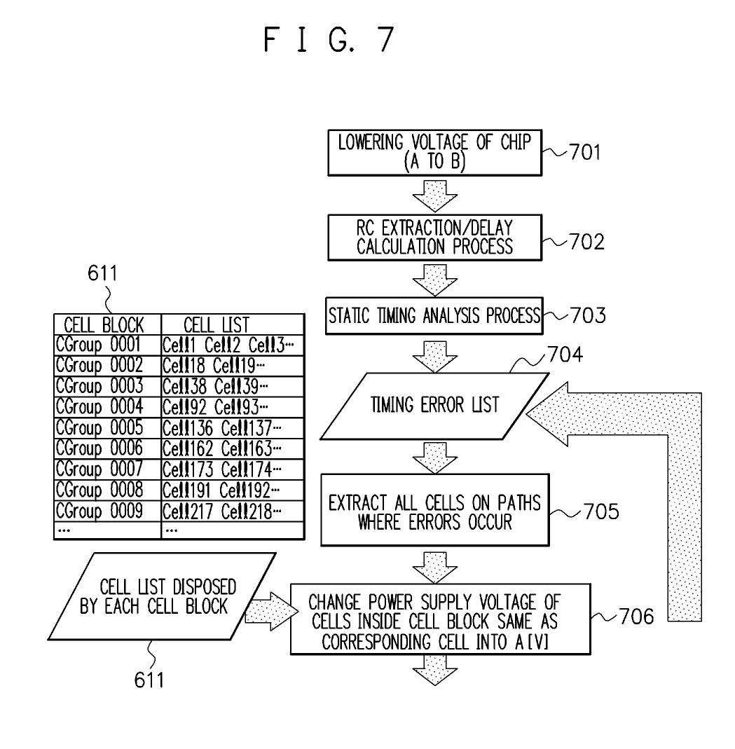

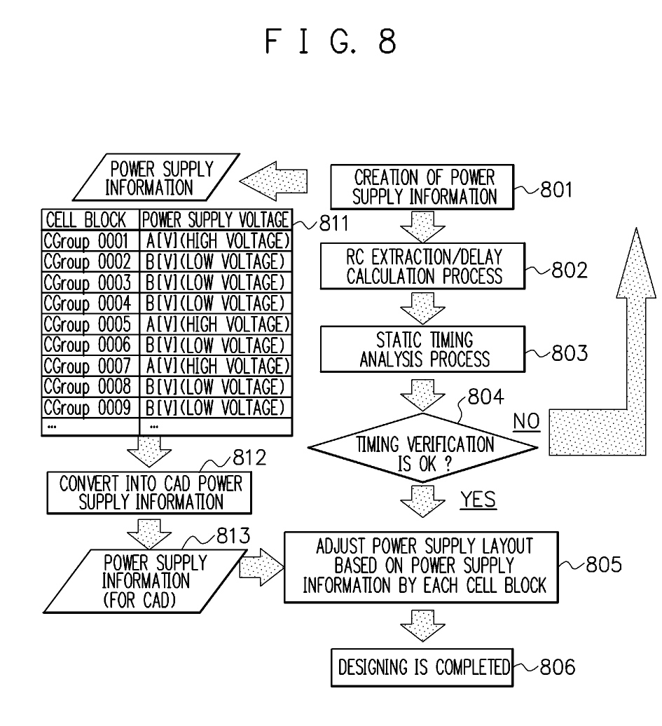

FIG. 6 to FIG. 8 are flowcharts illustrating a designing method of a designing apparatus of the present embodiment. FIG. 6 is the flowchart illustrating the designing method of the semiconductor chip 101 with high power supply voltage (for example, 1.2 V), and FIG. 7 and FIG. 8 are the flowcharts illustrating the designing method in which the power supply voltage of the semiconductor chip 101 with high power supply voltage (for example, 1.2 V) is lowered.

At first, the designing method of the semiconductor chip 101 with high power supply voltage (for example, 1.2 V) is illustrated with reference to FIG. 6. The designing apparatus generates a net list design data 601 of the semiconductor chip 101 with high power supply voltage (for example, 1.2 V). All cells receive the supply of the high power supply voltage (for example, 1.2 V) in the semiconductor chip 101.

Next, the designing apparatus performs a layout design process (floor plan) based on the net list design data 601, at step 602. Next, the designing apparatus performs a placement and wiring process, at step 603.

Next, the designing apparatus groups the cells inside the semiconductor chip 101 by each cell block preparing for lowering of the power supply voltage in future, and generates a cell list 611, at step 604. For example, a cell block CGroup0001 has cells Cell1, Cell2 and Cell3, and a cell block CGroup0002 has cells Cell18 and Cell19, in the cell list 611. The cell blocks CGroup0001 and CGroup0002 correspond to the cell blocks BL1 to BL9 in FIG. 5. The cell list 611 is used at later-described step 706 in FIG. 7.

Next, the designing apparatus performs an RC (resistance and capacitance values) extraction and a delay calculation process, to calculate a delay time, at step 605. The delay time is calculated based on the resistance value and the capacitance value. Next, the designing apparatus performs the static timing analysis process (STA) based on the delay time, at step 606.

Next, the designing apparatus compares the above-stated calculated delay time and the design timing constraint, and checks whether the timing verification is passed or not, at step 607. If it is passed, the designing process is completed, and if it is not passed, the process goes to step 608. The designing apparatus performs the timing adjusting process such as a buffer insertion between cells at the step 608, and goes back to the step 603. After that, the above-stated processes are repeated.

As stated above, the semiconductor chip 101 with high power supply voltage repeats the above-stated processes until the timing verification is passed, and the semiconductor chip is manufactured.

Next, the one is designed in which the power supply voltage of the above-stated semiconductor chip 101 with high power supply voltage (for example, 1.2 V) is lowered according to needs after that. The designing method is described with reference to FIG. 7 and FIG. 8.

FIG. 7 and FIG. 8 are the flowcharts illustrating the designing method in which the power supply voltage of the semiconductor chip 101 with high power supply voltage (for example, 1.2 V) is lowered.

The designing apparatus adjusts the design data of the semiconductor chip 101 with high power supply voltage generated by the processes in FIG. 6, to lower the power supply voltage of the semiconductor chip 101 with high power supply voltage in FIG. 6, at step 701. Concretely speaking, the power supply voltage of the semiconductor chip 101 is changed from the high power supply voltage A [V] to the low power supply voltage B [V] as illustrated in FIG. 4. A design data of the semiconductor chip 101 with low power supply voltage is generated by the above-stated adjustment. The low power supply voltage (for example, 1.0 V) is supplied to the cells inside the semiconductor chip 101. When the power supply voltage is lowered, the operating current becomes small, and therefore, the delay time of the cell becomes long.

Next, the designing apparatus performs the RC (resistance and capacitance values) extraction and the delay calculation process to calculate the delay time, at step 702. The delay time is calculated based on the resistance value and the capacitance value, and it becomes short when the power supply voltage is high and becomes long when the power supply voltage is low as stated above.

Next, the designing apparatus performs the static timing analysis process (STA) based on the delay time, at step 703. Next, the designing apparatus compares the above-stated calculated delay time and the design timing constraint, and checks whether the timing verification is passed or not. The designing apparatus generates a list of paths where the timing errors occur and the timing verifications are not passed, as a timing error list 704.

Next, the designing apparatus extracts all cells on the paths when the timing errors occur based on the timing error list 704, at step 705. For example, the cells CL1, CL5 and CL7 in FIG. 4 are extracted.

Next, the designing apparatus changes the power supply voltage of all cells in the same cell block as the cells extracted at the step 705 from the low power supply voltage B [V] to the high power supply voltage A [V] based on the cell list 611 generated in FIG. 6, at the step 706. Namely, the power supply voltages of the cells on the paths where the timing errors occur are returned from the low power supply voltage B [V] to the high power supply voltage A [V], and thereby, the occurrences of the timing errors are prevented. At this time, the power supply voltages of the cells inside the same cell block as the cells on the paths where the timing errors occur are also returned to the high power supply voltage A [V]. The design data of the semiconductor chip 101 in FIG. 4 is adjusted to the design data of the semiconductor chip 101 in FIG. 5 by the above-stated process.

Next, the designing apparatus generates power supply information 811 based on the change process at the step 706, at step 801 in FIG. 8. The power supply information 811 is information illustrating that the power supply voltage of each cell block is either the high power supply voltage A [V] or the low power supply voltage B [V]. For example, the cell block CGroup0001 is the high power supply voltage A [V], and the cell block CGroup0002 is the low power supply voltage B [V].

Next, the designing apparatus converts the power supply information 811 into CAD power supply information 813, at step 812.

Next, the designing apparatus performs the RC (resistance and capacitance values) extraction and the delay calculation process to calculate the delay time, at step 802. The delay time is calculated based on the resistance value and the capacitance value. Next, the designing apparatus performs the static timing analysis process (STA) based on the delay time, at step 803. The static timing analysis process is performed under a state in which the power supply voltage is set to be the high power supply voltage A [V] or the low power supply voltage B [V] by each cell block.

Next, the designing apparatus compares the above-stated calculated delay time and the design timing constraint, and checks whether the timing verification is passed or not, at step 804. If it is passed, the process goes to step 805. If it is not passed, the designing apparatus generates a list of paths where the timing errors occur and the timing verifications are not passed as the timing error list 704, and the process returns to the step 705 in FIG. 7. After that, the above-stated processes are repeated.

The designing apparatus adjusts a power supply layout based on the CAD power supply information 813 by each cell block, to generate a design data, at step 805. Concretely speaking, the positions of the via connection portions VA are adjusted as illustrated in FIG. 5. The via connection portions VA are provided so that the power supply voltage lines VDD of the cell blocks with high power supply voltage are connected to the high power supply voltage supply lines VDD1, and the power supply voltage lines VDD of the cell blocks with low power supply voltage are connected to the low power supply voltage supply lines VDD2. After that, the process goes to step 806, to complete the designing process.

As stated above, according to the present embodiment, it is possible to prevent the occurrences of the timing errors by supplying the high power supply voltage to the cell blocks including cells where the timing errors occur under the low power supply voltage, when the power supply voltage of the semiconductor chip 101 with high power supply voltage is lowered.

Besides, it is possible to eliminate the timing error by the adjusting process in short time without redoing the layout design, because it is only to adjust the positions of the via connection portions VA selecting the two kinds of power supply voltages supplied by each cell block.

Besides, the cell block to which the low power supply voltage is supplied can reduce the power consumption compared to the case of the high power supply voltage. Accordingly, the more the number of the low power supply voltage cell blocks is, the smaller the power consumption becomes.

Incidentally, the case is described as an example in the above in which the power supply voltages are two kinds of the high power supply voltage and the low power supply voltage, but the power supply voltages may be selected by each cell block from among three kinds or more different power supply voltages.

In the designing method of the semiconductor device of the present embodiment in FIG. 7, the step 701 is a power supply voltage changing step inputting the design data of the semiconductor device with a first power supply voltage which is divided into plural cell blocks and without timing error, and changing the design data of the semiconductor device with the first power supply voltage into the design data of the semiconductor device with a second power supply voltage (low power supply voltage) which is lower than the first power supply voltage. The step 702 is a first delay calculation step calculating the delay time of the semiconductor device with the second power supply voltage based on the design data of the semiconductor device with the second power supply voltage. The step 703 is a first static timing analysis step detecting the timing error by performing the static timing analysis process based on the delay time of the semiconductor device with the second power supply voltage. The step 706 is a power supply voltage supplying step generating the design data so as to supply the first power supply voltage to the power supply voltage lines of the cell blocks including the cells on the paths where the timing errors are detected, and to supply the second power supply voltage to the power supply voltage lines of the cell blocks other than the above.

As illustrated in FIG. 2, the power supply voltage lines of the plural cell blocks are separated by each cell block. Besides, the reference potential lines of the plural cell blocks are connected with each other.

Besides, in FIG. 6, the step 602 is a layout designing step performing a layout design process of the semiconductor device with the first power supply voltage (high power supply voltage). The step 603 is a placement and wiring step performing the placement and wiring process of the semiconductor device with the first power supply voltage on the design data. The step 604 is a cell block dividing step dividing the semiconductor device with the first power supply voltage into plural cell blocks. The step 605 is a second delay calculation step calculating the delay time of the semiconductor device with the first power supply voltage based on the design data of the semiconductor device with the first power supply voltage. The step 606 is a second static timing analysis step detecting the timing error by performing the static timing analysis process based on the delay time of the semiconductor device with the first power supply voltage. The step 608 is a timing adjusting step performing the timing adjusting process on the design data when the timing error is detected. In the step 701 in FIG. 7, the design data of the semiconductor device with the first power supply voltage without timing error is inputted.

Besides, in FIG. 8, the step 802 is a third delay calculation step calculating the delay time of the semiconductor device with the second power supply voltage based on the design data of the semiconductor device with the second power supply voltage after the steps in FIG. 7. The step 803 is a third static timing analysis step detecting the timing error by performing the static timing analysis process based on the delay time of the semiconductor device with the second power supply voltage, and returning to the power supply voltage supplying step when the timing error is detected. The step 805 is a layout design adjusting step adjusting the layout design data so as to connect the power supply voltage lines of the cell blocks to which the first power supply voltages are supplied to the first power supply voltage supply lines at the power supply voltage supplying step, and to connect the power supply voltage lines of the cell blocks to which the second power supply voltages are supplied to the second power supply voltage supply lines at the power supply voltage supplying step, when the timing error is not detected.

Besides, the semiconductor device (semiconductor chip) 101 has the plural cell blocks BL having the power supply voltage lines VDD separated from one another, and the plural power supply voltage supply lines VDD1, VDD2 to which the power supply voltages different from one another are supplied. The power supply voltage lines VDD of the plural cell blocks BL are connected to either one of the plural power supply voltage supply lines VDD1, VDD2 by each cell block BL. The reference potential lines VSS of the plural cell blocks BL are connected with each other.

According to the present embodiment, it is possible to reduce the power consumption by lowering the power supply voltage, to prevent the timing error and to prevent the redo of the layout design caused by the timing error.

Incidentally, the above-described embodiments are to be considered in all respects as illustrative and no restrictive. Namely, the present embodiment may be embodied in other specific forms without departing from the spirit or essential characteristics thereof.

It is possible to reduce power consumption, to prevent a timing error, and to prevent the redo of a layout design caused by the timing error by lowering a power supply voltage.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A designing method of a semiconductor device, comprising:
changing a power supply voltage inputting a design data of a semiconductor device with a first power supply voltage which is divided into plural cell blocks and without timing error, and changing the design data of the semiconductor device with the first power supply voltage into a design data of a semiconductor device with a second power supply voltage which is lower than the first power supply voltage;
performing a first delay calculation calculating a delay time of the semiconductor device with the second power supply voltage based on the design data of the semiconductor device with the second power supply voltage;
performing a first static timing analysis detecting the timing error by performing a static timing analysis process based on the delay time of the semiconductor device with the second power supply voltage; and
supplying a power supply voltage generating a design data to supply the first power supply voltages to power supply voltage lines of the cell blocks in which cells on paths where the timing errors are detected are included, and to supply the second power supply voltages to the power supply voltage lines of the other cell blocks.

2. The designing method of the semiconductor device according to claim 1,
wherein the power supply voltage lines of the plural cell blocks are separated by each cell block.

3. The designing method of the semiconductor device according to claim 2,
wherein reference potential lines of the plural cell blocks are connected with each other.

4. The designing method of the semiconductor device according to claim 1, further comprising:
designing a layout performing a layout design process of the semiconductor device with the first power supply voltage;
performing a placement and wiring performing a placement and wiring process of the semiconductor device with the first power supply voltage on the design data;
dividing into cell blocks dividing the semiconductor device with the first power supply voltage into plural cell blocks;
performing a second delay calculation calculating a delay time of the semiconductor device with the first power supply voltage based on the design data of the semiconductor device with the first power supply voltage;
performing a second static timing analysis detecting the timing error by performing the static timing analysis process based on the delay time of the semiconductor device with the first power supply voltage; and
adjusting a timing performing a timing adjusting process on the design data when the timing error is detected, and
wherein the changing the power supply voltage inputs the design data of the semiconductor device with the first power supply voltage without the timing error.

5. The designing method of the semiconductor device according to claim 4, further comprising:
performing a third delay calculation calculating a delay time of the semiconductor device with the second power supply voltage based on the design data of the semiconductor device with the second power supply voltage after the supplying the power supply voltage;
performing a third static timing analysis detecting the timing error by performing the static timing analysis process based on the delay time of the semiconductor device with the second power supply voltage, and returning the supplying the power supply voltage when the timing error is detected; and
adjusting a layout design adjusting a layout design data to connect the power supply voltage lines of the cell blocks to which the first power supply voltages are supplied at the supplying the power supply voltage to the first power supply voltage supply lines, and to connect the power supply voltage lines of the cell blocks to which the second power supply voltages are supplied at the supplying the power supply voltage to the second power supply voltage supply lines.

6. A designing apparatus of a semiconductor device, comprising:
a power supply voltage changing unit inputting a design data of a semiconductor device with a first power supply voltage which is divided into plural cell blocks and without timing error, and changing the design data of the semiconductor device with the first power supply voltage into a design data of a semiconductor device with a second power supply voltage which is lower than the first power supply voltage;
a first delay calculation unit calculating a delay time of the semiconductor device with the second power supply voltage based on the design data of the semiconductor device with the second power supply voltage;
a first static timing analysis unit detecting a timing error by performing a static timing analysis process based on the delay time of the semiconductor device with the second power supply voltage; and
a power supply voltage supplying unit generating a design data to supply the first power supply voltages to power supply voltage lines of the cell blocks in which cells on paths where the timing errors are detected are included, and to supply the second power supply voltages to the power supply voltage lines of the other cell blocks.

7. A semiconductor device, comprising:
a plurality of cell blocks comprising power supply voltage lines separated from one another; and
a plurality of power supply voltage supply lines to which power supply voltages different from one another are supplied,
wherein the power supply voltage lines of the plural cell blocks are connected to either one of the plural power supply voltage supply lines by each of the cell blocks.

8. The semiconductor device according to claim 7,
wherein reference potential lines of the plural cell blocks are connected with each other.
